(19) United States
(12) Patent Application Publication
(10) Pub. No.: US 2014/0347163 A1
(43) Pub. Date: Nov. 27, 2014

(54) VEHICLE ACCESS SYSTEM AND CONTROLLER THEREFOR

(71) Applicants: C. Bruce Banter, Northville, MI (US); Jeffrey Stokes, Milan, MI (US); Marcus Merideth, Westland, MI (US); Rob Bingle, Walker, MI (US)

(72) Inventors: C. Bruce Banter, Northville, MI (US); Jeffrey Stokes, Milan, MI (US); Marcus Merideth, Westland, MI (US); Rob Bingle, Walker, MI (US)

(21) Appl. No.: 14/370,348

(22) PCT Filed: Jan. 7, 2013
(86) PCT No.: PCT/US2013/020509

§ 371 Date: Jul. 2, 2014

Related U.S. Application Data
(60) Provisional application No. 61/583,343, filed on Jan. 5, 2012.

(51) Int. Cl. B60R 25/01; G07C 9/00

(52) U.S. Cl. CPC B60R 25/01; G07C 9/0069; G07C 2009/00642
USPC 340/5.72

(57) ABSTRACT

A system for accessing a vehicle when the main battery is incapable of supplying sufficient power for actuating the vehicle's power door locks/latches comprises: a power supply in the door or release handle supplying power to the vehicle's power latch; an entry authentication device for receiving one or more inputs for authenticating a user's access to the vehicle, the entry authentication device powered by the rechargeable power supply; and a latch controller powered by the power supply and operatively connected to the power latch and the at least one entry authentication device to receive information from the entry authentication device corresponding to the one or more inputs. The latch controller can authenticate a user's access to the vehicle to place the power latch in an unlocked state so that the door can be opened.

### CROSS-REFERENCE TO RELATED APPLICATIONS

This application is related to, and claims the benefit of priority from, U.S. Provisional Patent Application Ser. No. 61/583,343, filed 5 Jan. 2012, the disclosure of which application is incorporated herein by reference in its entirety.

### FIELD OF THE INVENTION

The present disclosure relates generally to access systems for vehicles having doors with power latches, and more particularly to systems and apparatus for actuating the power latches even when the vehicle's main battery is sufficiently depleted such that the vehicle's other electrically-powered systems are rendered inoperative.

### BACKGROUND

Vehicle doors conventionally include a door latch mechanism housed between inner and outer panels of the door. The latch mechanism cooperates with elements provided on the door frame to latch the door when closed and, in cooperation with a user-actuated release handle, to unlatch the door so that the door can be opened manually.

Historically, vehicle latch mechanisms were entirely mechanical, with each door's release handles being mechanically connected to the latch. Increasingly, however, mechanical systems in vehicles, and particularly automobiles, are being replaced by, or augmented with, electromechanical systems. More particularly, vehicles are increasingly being provided with electronic latches, according to which user operation of the outside release handle will signal actuation, via the body control module, of an electromechanical latch mechanism. By such means, purely mechanical linkage between the release handle and the door latch mechanism is obviated.

Current vehicle entry systems utilize key-actuated, mechanical back-up systems to provide secured access to vehicles whose power locks/latches have failed because of failure of the vehicle's main battery. One example of such a conventional power lock/latch system incorporating both an electronic lock/latch and mechanical back-up is shown in FIG. 1. For the primary, electronic lock/latch system, the vehicle's main battery 1 powers (indicated by dotted lines) each of the vehicle's entry control module 2 (such as the body control module or other controller responsible for vehicle entry) and antenna 3 (typically positioned in the outside release handle 4) for sending a challenge signal to a remote transmitter 5 (typically incorporated into the vehicle's key fob and so commonly referred to as a “key fob remote”). Per convention, after the antenna 3 sends the challenge signal 6 to the key fob remote 5, the entry control module 2 receives an authentication signal 7 from the key fob remote 5. Upon authentication of that signal 7 by the entry control module 2, the entry control module places a previously locked vehicle in an “unlocked” state in which subsequent operation of the release handle 4 will effect unlatching of the vehicle door. Still more particularly, subsequent operation of the release handle 4 will signal (depicted by the dashed line 8) the entry control module 2 to actuate (depicted by the dashed line 8) an electromechanical motor that unlatches the mechanical door latch 10. Alternatively, according to other conventional designs, the entry control module 2, upon authentication of the signal 7, powers a door latch actuator which mechanically couples the release handle 4 and the door latch 10 to define the unlocked state of the vehicle.

In the event of main battery 1 power failure, a secondary, mechanical system comprising an unlocking/unlatching mechanism 11 (such as, for instance, a key lock cylinder as depicted) is mechanically connected (indicated at solid line 12) to the latch 10 to permit entry into the vehicle. Where these mechanical back-ups are placed within the door, they require space and depth in doors that are becoming increasingly thinner and packed with more components as vehicles become more complex, thereby introducing increasing design constraints. For instance, conventional mechanical locks require a minimum depth of 45 mm, which is difficult to package in a typical door having a window glass and track mechanism. And where these mechanical back-ups are placed elsewhere on the vehicle, such placement tends to be inconvenient for the vehicle operator, making it more difficult to open the vehicle in the event of main battery failure.

### SUMMARY

In addressing the drawbacks of the prior art, there is disclosed an access system, as well as a controller forming a subassembly of such an access system, for a vehicle of the type having at least one onboard electrical power source comprising a main battery, at least one door with a power latch powered by the main battery and a user-actuatable release handle for opening the at least one door, the access system facilitating access to the vehicle when the vehicle's main battery is incapable of supplying sufficient power for actuating the power latch. The access system comprises at least:

(a) a power supply disposed in one of the at least one door or the release handle, the power supply supplying power to the power latch;

(b) at least one entry authentication device provided on the vehicle for receiving one or more inputs for authenticating a user's access to the vehicle, the entry authentication device powered by the power supply; and

(c) a latch controller positioned in the vehicle, the latch controller powered by the power supply, the latch controller operatively connected to the power latch and the at least one entry authentication device to receive information from the at least entry authentication device corresponding to the one or more inputs, and the latch controller operative to authenticate a user's access to the vehicle based on the information received from the at least one entry authentication device.

On authentication of the information received from the entry authentication device, the latch controller places the power latch in one of a locked or an unlocked state, the unlocked state being characterized in that the power latch is operatively coupled to the release handle, and the locked state being characterized in that the power latch is operatively uncoupled from the release handle.

In one embodiment, the entry authentication device is a key pad, the one or more inputs are a sequence of numbers and/or letters corresponding to one or more keys on the key pad, and authentication of the information received from the entry authentication device corresponds to one or more inputs entered according to a predefined passcode. The key pad may, per one embodiment, be provided on one of the release handle or vehicle door.

In one embodiment, the at least the latch controller and power supply are provided within a unitary housing mountable in a vehicle door.

In one embodiment, the power supply comprises a rechargeable power supply, and the access system further comprises a power management controller for monitoring the status of the rechargeable power supply and for controlling recharging of the rechargeable power supply via the vehicle's at least one onboard electrical power source, the power management controller disposed in one of the at least one door or the release handle and powered by the rechargeable power supply. The latch controller, power management controller and power supply may all be provided within a unitary housing mountable in a vehicle door.

Where the power supply is rechargeable, the present invention may further include means positioned in the vehicle for transferring power from an external power supply to the rechargeable battery via the power management controller in order to selectively recharge the rechargeable power supply. In one embodiment, the external power supply is directly connectable to the power transferring means. In another embodiment, the external power supply is indirectly connectable to the power transferring means via induction.

In one form of the present invention, the at least one onboard electrical power source of the vehicle in which the access system is incorporated includes a 12 Volt DC power source separate from the vehicle's main battery and, furthermore, the power management controller controls recharging of the rechargeable power supply via said 12 Volt DC power source separate. Such 12 Volt DC power source may, for instance, comprise the power source for the vehicle's ignition system.

Where the vehicle is of the type including a power latch having a latch pawl and a latch pawl switch, the access system may further comprise the latch controller being operatively connected to the latch pawl switch, and wherein the latch pawl switch is operative to convey information to the latch controller respecting the position of the latch pawl.

Where the vehicle is of the type including a door ajar switch, the access system may further comprise the latch controller being operatively connected to the door ajar switch, and wherein the door ajar switch is operative to convey information to the latch controller respecting whether the vehicle door is opened or closed.

Where the vehicle is of the type further comprising an entry control module powered by the vehicle's main battery, the access system may comprise:

the entry control module being operatively connected to the power latch and the entry authentication device via the latch controller, the entry control module operative to receive information from the entry authentication device corresponding to the one or more inputs, and the entry control module operative to authenticate a user's access to the vehicle based on the information received from the at least one entry authentication device and to place the power latch in one of the locked or unlocked states thereof via the latch controller; and the power management controller being operatively connected to the entry control module, and the power management controller operative to determine, via the entry control module, when the vehicle's main battery is capable of supplying sufficient power for actuating the power latch. When the power management controller determines that the vehicle's main battery is capable of supplying sufficient power for actuating the power latch, the access system is not powered by the rechargeable power supply, and the entry control module exclusively authenticates a user's access to the vehicle based on the information received from the at least one entry authentication device, and exclusively places the power latch in one of the locked or unlocked states thereof.

The present disclosure also comprehends an apparatus comprising a subassembly of the access system of the present invention, the apparatus comprising at least: (a) a power supply positionable in one of the at least one door or the release handle, the power supply operatively connectable to the power latch and the entry authentication device so as to supply power thereto; and (b) a latch controller positionable in the vehicle, the latch controller powered by the power supply, the latch controller operatively connectable to the power locks and the at least one entry authentication device to receive information from the at least entry authentication device corresponding to the one or more inputs, and the latch controller operative to authenticate a user's access to the vehicle based on the information received from the at least one entry authentication device. On authentication of the information received from the entry authentication device, the latch controller is operative to place the power latch in one of a locked or an unlocked state, the unlocked state being characterized in that the power latch is operatively coupled to the release handle, and the locked state being characterized in that the power latch is operatively uncoupled from the release handle.

### BRIEF DESCRIPTION OF THE DRAWINGS

The foregoing and other features of the present invention will be better understood on reference to the written description and accompanying drawings, of which:

FIG. 1 is a schematic depiction of a vehicle access system according to the prior art;

FIG. 2 is a schematic depiction of a vehicle access system according to an exemplary embodiment of the present invention;

FIG. 3a is perspective view of an apparatus according to the present invention, the apparatus shown as partially transparent for purposes of illustration;

FIG. 3b depicts in perspective a vehicle door having mounted therein the apparatus of FIG. 3a;

FIG. 3c is an exploded perspective view of the apparatus of FIG. 3a;

FIG. 3d is a perspective view of the several components contained in the interior of the apparatus of FIG. 3a;

FIG. 3e an alternate perspective view of an apparatus according to the present invention, the apparatus shown as partially transparent for purposes of illustration;

FIG. 4 is a perspective view of an apparatus according to the present invention, per an alternative embodiment;

FIG. 5 is a schematic depiction of a vehicle access system according to another exemplary embodiment of the present invention;

FIGS. 6 and 7 illustrate example external power connection locations and direct connectors according to the embodiment of the invention disclosed in relation to FIG. 5;

FIGS. 8 and 9 illustrate example access devices combined with power supply remote from an automobile for direct and indirect connection to a power lock system of a vehicle according to the embodiment of the invention disclosed in relation to FIG. 5;

FIG. 10 illustrates various example vehicle locations for mounting direct and indirect connection to a vehicle according to the embodiment of the invention disclosed in relation to FIG. 5; and

FIG. 11 is a flowchart depicting an exemplary operation of the present invention.

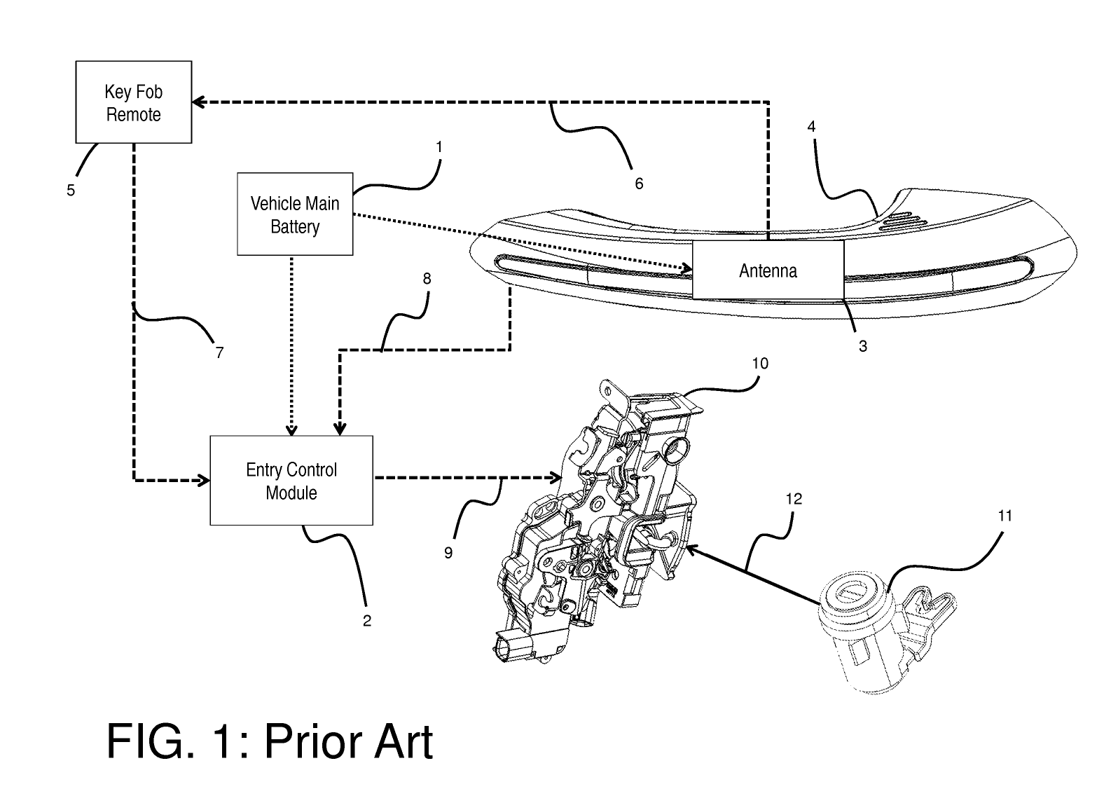

### WRITTEN DESCRIPTION

Referring now to the drawings, which are representative of exemplary embodiments of the present invention only and so are not necessarily to scale, the present invention will be seen to generally comprise an access system for a vehicle of the type having at least one onboard electrical power source comprising a main battery, at least one door with a power latch powered by the main battery and a user-actuatable release handle for opening the at least one door, the access system facilitating access to the vehicle when the vehicle's main battery is incapable of supplying sufficient power for actuating the power latch, the access system comprising:

(a) a power supply disposed in one of the at least one door or the release handle, the power supply supplying power to the power latch;

(b) at least one entry authentication device provided on the vehicle for receiving one or more inputs for authenticating a user's access to the vehicle, the entry authentication device powered by the power supply

(c) a latch controller positioned in the vehicle, the latch controller powered by the power supply, the latch controller operatively connected to the power latch and the at least one entry authentication device to receive information from the at least entry authentication device corresponding to the one or more inputs, and the latch controller operative to authenticate a user's access to the vehicle based on the information received from the at least one entry authentication device. On authentication of the information received from the entry authentication device, the latch controller places the power latch in one of a locked or an unlocked state, the unlocked state being characterized in that the power latch is operatively coupled to the release handle, and the locked state being characterized in that the power latch is operatively uncoupled from the release handle.

According to the exemplary embodiment of the invention as described herein, the power supply comprises a rechargeable power supply, and the access system further comprises a power management controller for monitoring the status of the rechargeable power supply and for controlling recharging of the rechargeable power supply via the vehicle's at least one onboard electrical power source, the power management controller disposed in one of the at least one door or the release handle and powered by the rechargeable power supply. However, it will be appreciated with the benefit of this disclosure that the power supply may be a single-charge power supply that is replaceable upon depletion, rather than being rechargeable.

As used herein, the term “power latch” is intended to refer to the essential components of a vehicle's powered door latch system which are electrically, mechanically, and/or electromechanically “downstream” from a door's release handle and operative, in combination with user actuation of the release handle, to open the door. According to the prior art, a “power latch” may comprise, for example and without limitation, the vehicle's door latch and door latch actuator, which door latch actuator is selectively actuated to mechanically couple the release handle and the door latch. Still other “power latches” may comprise, for instance, an electromechanical motor that unlatches the mechanical door latch in response to an electrical signal indicating that a user is actuating the release handle. In respect of the foregoing, the release handle may comprise, for instance and without limitation, one or more sensors, such as a capacitive sensor, operative to detect when the user is touching a predefined area of the release handle. The vehicle's “power latches,” in these regards, would comprise an electromechanical motor that unlatches the mechanical door latch in response to an electrical signal that the user is actuating the release handle by touching it. Consequently, it will be understood that “user actuation,” as the term is used herein, refers to such action(s) on the part of the user required to result in the release handle's effecting, via the vehicle's “power latch,” opening of an unlocked vehicle door. It does not strictly contemplate or require that a user physically move (e.g., pivot or pull) a handle. From the foregoing, it will also be appreciated that the present invention may be adapted to work in combination with any kind of release handle, whether mechanical, electrical or electromechanical in its connection to the vehicle's “power latches.”

As will be appreciated by those skilled in the art, the terms “locked” and “unlocked” comprehend the states of a vehicle's power latch in which the components thereof are coupled or uncoupled from the door's release handle so as to permit or prevent, respectively, opening of a vehicle's door by user actuation of the release handle. Accordingly, the door of a vehicle in an unlocked state can be opened, whereas the door of a vehicle in a locked state cannot.

In summary, the access system of the present invention permits one or more of a vehicle's doors to be unlocked and opened (as well as, conversely, closed and locked), including in the event that the vehicle's main battery is depleted to the point that the vehicle's other electrically powered systems are rendered inoperative.

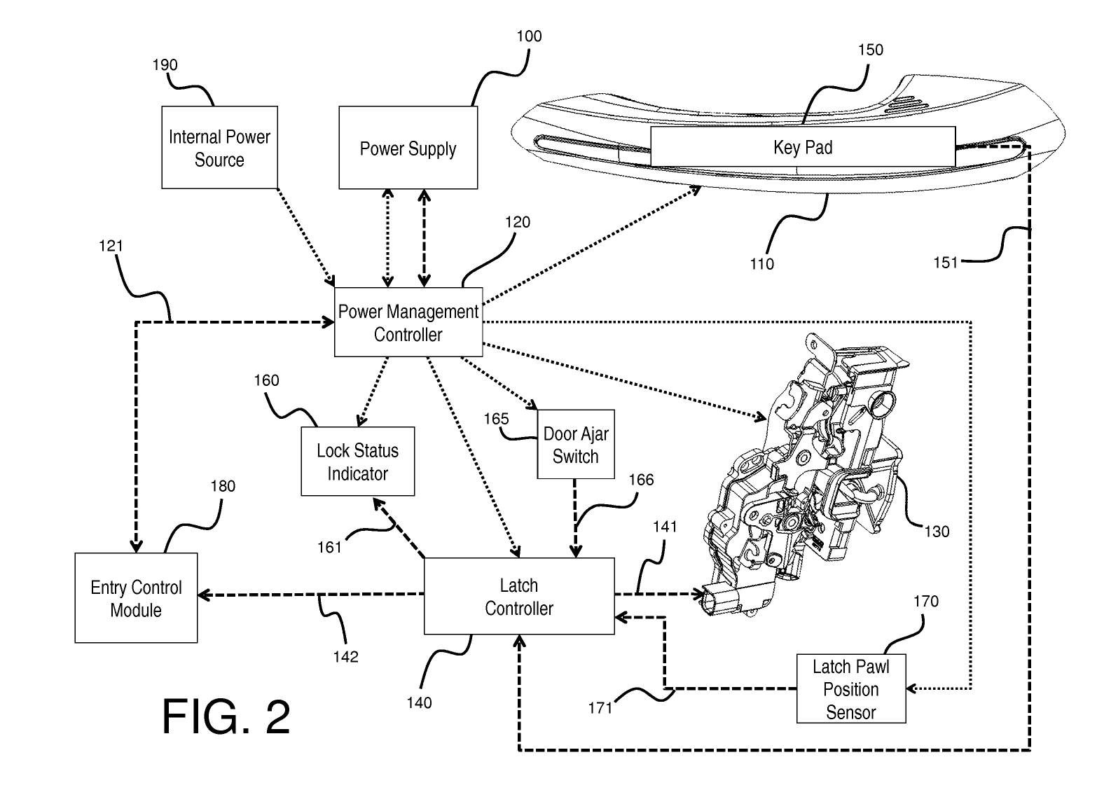

As shown in the schematic of FIG. 2, depicting the present invention according to a first exemplary embodiment, this is effected by the provision of a power supply 100 disposed in the vehicle door or, optionally, as discussed herein, in the release handle 110, the power supply 100 powering (indicated by dotted lines) each of a power management controller 120 and a latch controller 140 and, either directly or via the power management controller 120, powering the vehicle power latch 130 (shown in FIG. 2 in simplified form as an exemplary vehicle latch), and an entry authentication device in the form of a key pad 150 provided on the release handle 110 for unlocking/locking the vehicle upon entry of authentication information in the form of a predefined access code.

Optionally, the power supply may also power a lock status indicator 160 (shown by a dotted line between the power management controller and lock status indicator), such as an LED light positioned on the door, for providing a visual indicator to the user as to whether the vehicle is in a locked or unlocked state. Latch controller 140 is operatively connected (via the line of communication represented by dashed line 161) to the door ajar switch 165 to control operation of the visual indicator depending upon whether the vehicle is in a locked or unlocked state.

Optionally, where the vehicle is of the type including a door ajar switch 165, latch controller 140 may be operatively connected (via the line of communication represented by dashed line 166) to the door ajar switch 165, and the door ajar switch may be operative to convey information to the latch controller respecting whether the vehicle door is opened or closed. Where such a door ajar switch requires power, such power may be provided via the power supply 100 (shown by a dotted line between the power management controller and the door ajar switch).

Optionally, where the vehicle is of the type in which the latch 130 includes a latch pawl and there is provided a latch pawl switch 170, latch controller 140 may be operatively connected (via the line of communication represented by dashed line 171) to the latch pawl switch 170, and the latch pawl switch may be operative to convey information to the latch controller 140 respecting the position of the latch pawl. Where such a pawl switch requires power, such power may be provided via the power supply 100 (shown by a dotted line between the power management controller and the latch pawl switch).

These and other components of the access system according to the various exemplary embodiments of the invention are described in greater detail below.

### Power Supply and Power Management Controller

With continuing reference to FIG. 2, power supply 100 may comprise any suitable power supply, including of conventional manufacture. In the illustrated embodiments, power supply 100 is a rechargeable power supply such as, by way of non-limiting example, one or more rechargeable batteries, such as, for instance, lithium ion batteries, nickel-metal hydride batteries, etc. But while power supply 100 may be any conventional type of rechargeable battery or batteries suited to the purposes herein described, it should be noted that the selected battery or batteries will preferably (though not necessarily) be capable of permitting operation of the vehicle access system of the present invention a plurality of times before requiring recharging. It is possible that the power supply 100 may operate a higher voltage than the 12V commonly employed in automobiles and other vehicles, thereby optionally permitting more efficient operation of the power latch 130. Alternatively, the power supply 100 may operate at a lower voltage than 12V, in order to reduce costs and the size of the power source, save weight, etc. In any case, those skilled in the art will appreciate that the minimum voltage required of the power supply 100 will be determined by the power requirements of the system as herein described, including to effect operation of the vehicle's power latch (such as, for instance and without limitation, an electromechanical motor component thereof).

Further, while a rechargeable power supply is exemplified herein, it will be understood that the power supply 100 may be a conventional single-charge battery requiring periodic replacement. In such an embodiment of the present invention, it will be appreciated that access to the power supply 100 must be provided to facilitate the power supply's replacement as required.

Power supply 100 exclusively, and independently of the vehicle's main battery, provides operating power to each of the power latch 130, latch controller 140, power management controller 120, the entry authentication device (e.g., the key pad 150) and, as optionally included, the lock status indicator 160, door ajar switch 165, and/or pawl switch 170. Per convention, each of at least power supply 100, power latch 130, latch controller 140, and power management controller 120 are preferably (though not necessarily) positioned, as described hereafter, in the vehicle door D and/or release handle 110.

Power management controller 120 is operative to monitor the charge status of power supply 100 and, where power supply 100 is rechargeable, determine when recharging is required (i.e., when the charge status of power supply 100 falls below a predetermined threshold required to facilitate operation of the various components of the access system).

As depicted, power from the power supply 100 is routed through the power management controller 120 to various components of the access system. Of course, it will be appreciated that power supply 100 may, alternatively, also be more directly coupled to the various access system components powered thereby according to the exemplary embodiments of the invention.

Further, and as also depicted, a power source or power sources comprising part of the vehicle in the absence of the system of the present invention (such exemplified by the “internal power source” 190 in FIG. 2) for recharging the power supply 100 is/are electrically connected to the rechargeable power supply via the power management controller 120 (indicated by a dotted line between the power management controller and the power source). While internal power source 190 may comprise the vehicle's main battery, it is more preferably an ancillary power source, such as, by way of non-limiting example, the vehicle's ignition system power source (which is conventionally a 12 Volt DC power source). In this manner, the access system of the exemplary embodiment will not deplete the vehicle's main battery.

When it is determined that charging of the power supply 100 is required, power management controller 120 is operative, in a first embodiment (FIG. 2), to draw power from the internal power source 190. Preferably, though not necessarily, power management controller 120 is programmed to draw power from the internal power source 190 only at optimum times, such as, for instance, during periods of vehicle operation. To this end, power management controller 120 will preferably be in communication with the vehicle, via an appropriate controller or other computer already present in the vehicle (i.e., comprising part of the vehicle in the absence of the present invention) to determine the optimum times for recharging the power supply 100.

Power management controller 120 is further operatively connected to the vehicle's entry control module 180 (as represented by the dashed line 121) to determine when the entry control module is sufficiently powered to operate the vehicle's access system and, accordingly, not require operation of the access system of the present invention (in which circumstances the access system of the present invention is preferably programmed to defer to operation of the entry control module 180).

Optionally, power management controller 120 may be operative to monitor the charge status of the vehicle's internal power source 190 independently of the entry control module 180, such as, for instance, via a connection to the vehicle's ignition feed, as an additional or alternative means for determining whether or not operation of the access system of the present invention is required.

### Latch Controller

Latch controller 140, powered by the power supply 100 (as indicated by the dotted line extending from power management controller 120), is positioned in the vehicle and operatively connected to the power latch 130 and the at least one entry authentication device (e.g., the key pad 150). Latch controller 140 receives information from the entry authentication device 150 (as indicated by the dashed line 151) corresponding to the one or more inputs (e.g., the user's input, via the key pad, of a predefined passcode), and is operative to authenticate a user's access to the vehicle based on the information received from the at least one entry authentication device. On authentication of the information received from the entry authentication device 150, the latch controller 140 effects (via the line of communication 141) operation of the power latch 130 to place the power latch in one of a locked or an unlocked state (whereupon, when the handle is actuated by a user, the door may be opened or closed).

In effect, therefore, when the vehicle's main battery is incapable of powering the vehicle's access systems to permit a user to open the door, latch controller 140 functions to both authenticate a user's access to the vehicle and, upon such authentication, to place the power latch 130 in an unlocked or locked state (depending upon the initial state of the door). In such circumstances, latch controller 140 functions as the vehicle's entry control module (e.g., the body control module); albeit to the limited extent of permitting at least one of the vehicle's doors to be locked/unlocked and opened or closed. Consequently, it is to be understood that latch controller 140 is also programmed, like the vehicle's entry control module, to recognize the key pad inputs corresponding to the predefined passcode, in order to authenticate a user's access to the vehicle when the entry control module 180 is insufficiently powered due to a dead or depleted vehicle main battery.

Preferably, though not necessarily, information communicated to and from the latch controller 140 is secured in some conventional fashion (e.g., encrypted) so that the power latch 130 cannot be overridden by an unauthorized person.

According to the illustrated embodiments, including as described further below, latch controller 140 is unitary with the power management controller 120 and power supply 100, being integrated in one or more printed circuit boards (“PCBs”) programmed to perform in the manner described herein. Alternatively, as noted elsewhere, latch controller 140 may be separate from the power management controller 120 and rechargeable power supply 100.

With continued reference to FIG. 2, latch controller 140 is operatively connected to the vehicle's entry control module 180 (as indicated by the dashed line 142) so as to convey at least information respecting the lock state of the vehicle (i.e., locked or unlocked) as established by operation of the entry authentication device (e.g., key pad 150) and, optionally, signal inputs (indicated by dashed lines 161, 166, 171) from, for instance, a lock status indicator 160, a door ajar sensor 165, and/or a latch pawl position sensor 170. In this fashion, when the entry control module 180 is sufficiently powered to operate as normal, it will be understood that the access system of the present invention serves to pass necessary vehicle state information regarding the locked/unlocked and opened/closed conditions of one or more of the vehicle's doors to the entry control module 180. As, in the absence of the access system of this invention, the entry control module 180 would receive such inputs in a conventional vehicle, it will be appreciated from this disclosure that the access system is integrated into a vehicle's existing electronics so as to, in essence, be transparent to the vehicle's normal operations when the vehicle main battery is sufficiently powered to facilitate normal operation of the vehicle's access systems.

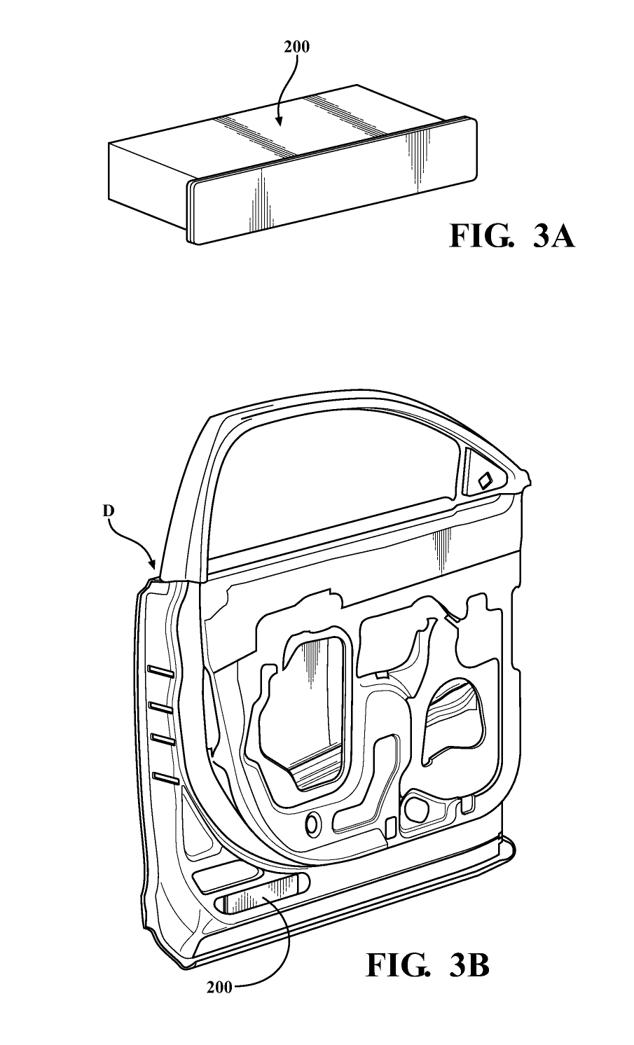

With reference to FIGS. 3a through 3e, it is contemplated by the exemplary embodiment that each of power supply 100, power management controller 120 and latch controller 140 are disposed within a housing 200 mountable within the door D of the vehicle (such as, as depicted, in the inside door panel prior to the interior trim being applied thereover). Still more particularly, housing 200 of the exemplary embodiment will be seen to include a base 201, a cover portion 202, and a face portion 203. A sealing gasket 205 is disposed between at least the face portion 203 and the rest of the housing, as shown in FIG. 3c. Also as depicted, a plurality of wires 210 extend from the housing, these wires providing the electrical communication for facilitating one or more of power supply and signal communication between the power supply 100, power management controller 120 and latch controller 140 and the various vehicle components as heretofore described. Optionally, these wires 210 terminate in one or more mating connectors (not depicted) matingly connectable to one or more corresponding connectors provided in the vehicle and, in turn, coupled to wires in electrical communication with the various vehicle components as heretofore described.

It will be appreciated from the foregoing that the present invention contemplates a minimum of modification to a vehicle's existing electrical systems where the access system is incorporated into an existing automobile not otherwise purposefully designed to integrate with the access system of this invention.

While power supply 100, power management controller 120 and latch controller 140 may be separated as necessary, including in response to design constraints associated with the vehicle in which they are to be incorporated, providing each component in a single module contained in the housing 200 according to the exemplary embodiment described above will be understood to simplify construction and installation of the invention, including in a mass-production environment such as implicated when the access system is incorporated into OEM vehicles.

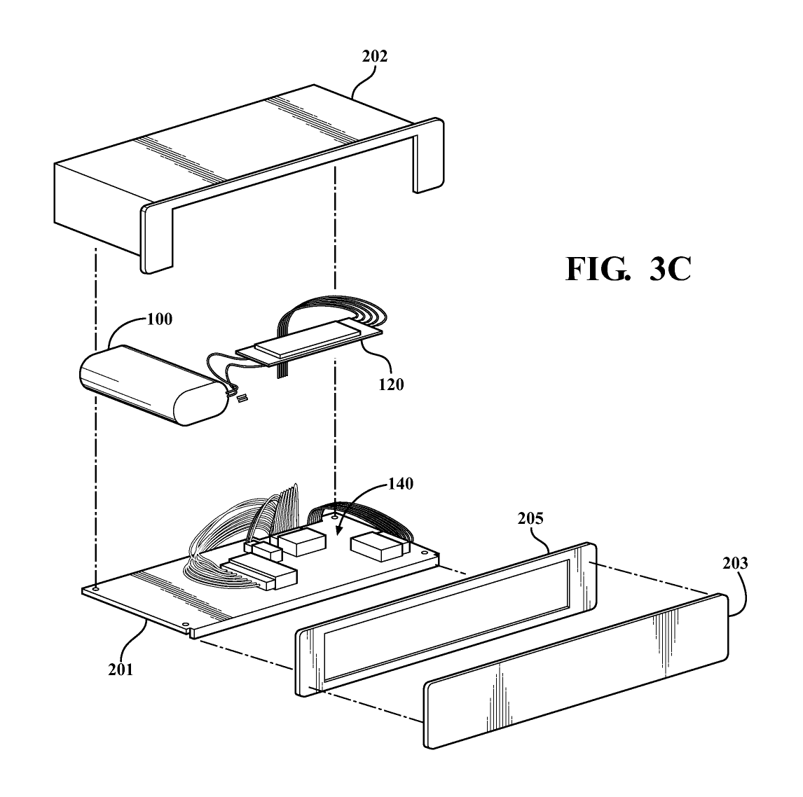

Referring next to FIG. 4, there is shown an alternative embodiment of a housing 200′ containing the power supply 100, power management controller 120 and latch controller 140 of the present invention as described elsewhere herein. According to this alternative embodiment, which except as indicated operates as the embodiment first described above, the housing 200′ is adapted to be integrated with a vehicle's release handle assembly (not depicted), rather than disposed elsewhere in the vehicle door. To this end, there is provided a sealed connector 230′ for interconnection with the vehicle's release handle, as well as a sealed door harness connector 231′, such as a pin-type connector as shown, by which the various components contained within the housing 200′ are electrically (both power and signal communication) coupled to other components integral to operation of the access system in its various embodiments, as described elsewhere herein. It will be appreciated that this disposition of the power supply 100, power management controller 120 and latch controller 140 advantageously permits the employment of shorter power connections between these components of the access system and the various elements connected thereto.

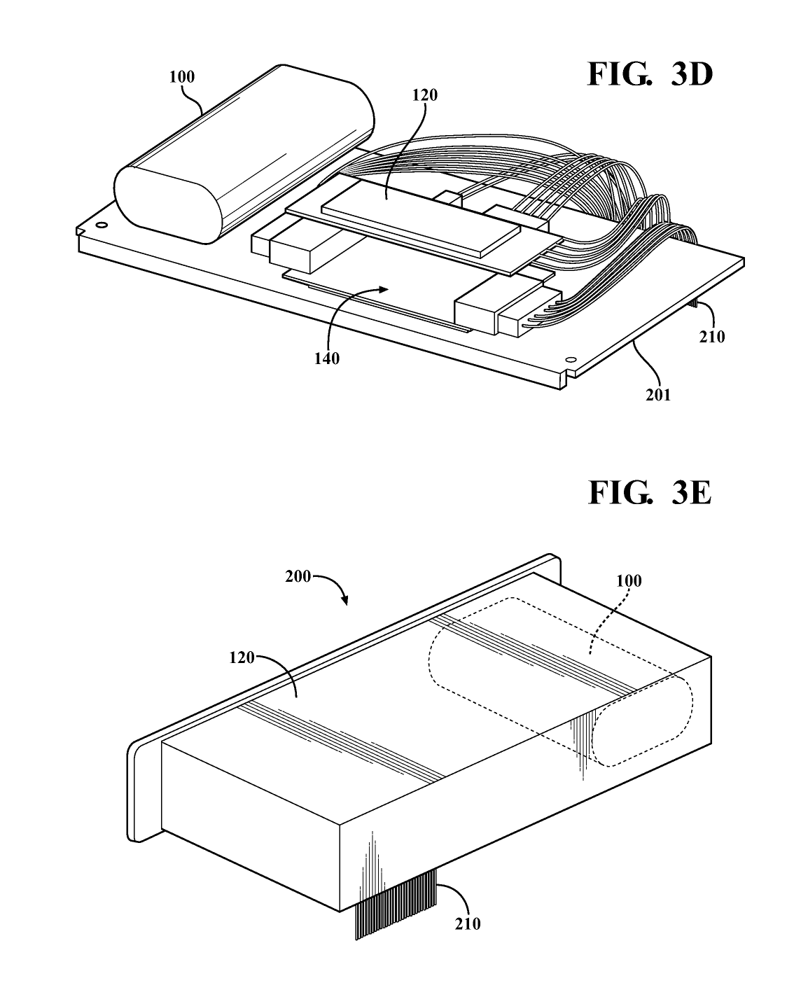

With reference now to the embodiments of FIGS. 5 through 10, power supply 100 may optionally be selectively recharged, via power management controller 120, by an external power source 300 (shown in dashed lines). External power source 300 generally comprises a source of power, connectable (as shown by dotted line 301) to a power transferring means 305 that is sufficient to recharge the power supply 100 via power management controller 120. The external power source 300 may comprise a low power (for instance, 12V, 9V or 5V DC) source, for example. Suitable sources may include, by way of non-limiting example, another vehicle's 12V power source (such as, for instance, a cigarette lighter), a cell phone, a laptop computer or a conventional battery. Where the external power source 300 constitutes an external device of conventional manufacture, the power transferring means 305 will comprise an interconnection suitable to the external device, such as any known plug/receptacle combination, suitable contacts (where, for instance, the external power source is simply a conventional battery), etc. Where, on the other hand, the external power source 300 is a device specifically designed for use in connection with the access system of the present invention, the power transferring means 305 will comprise a plug specifically designed for a correspondingly uniquely-shaped receptacle at the power transferring means 305.

Power transferring means 305 comprehend, most essentially, one or more electrical connections, accessible to a user from external locations on the vehicle, via which power from the external power supply 300 may be transferred to the power management controller 120 to facilitate recharging of the power supply 100.

The externally accessible portions of the power transferring means 305 may comprehend physical receptacles, such as USB ports, “cigarette-lighter plug”-style receptacles, specially-configured receptacles, etc., which are adapted to be coupled to the external power supply 300. However, it is also contemplated that the power transferring means 305 may comprehend means to effect the wireless transfer of power from the external power source 300 to the power supply 100 via the power management controller 120. In these regards, those skilled in the art will understand that there exist several different conventional means for wirelessly transferring power from a power source, including several different means of effecting inductive power transfer such as, for instance, electrodynamic induction. In electrodynamic induction, electric current flowing through a primary coil creates a magnetic field that wirelessly acts on a remote secondary coil to produce a current through a process known as mutual induction. According to the foregoing, whether by electrodynamic induction or other inductive power transfer, it is contemplated that the external power source 300 will constitute the component for generating the magnetic field, while the power transferring means 305 will constitute the component in which a current is induced, that current supplying power to the power supply 100.

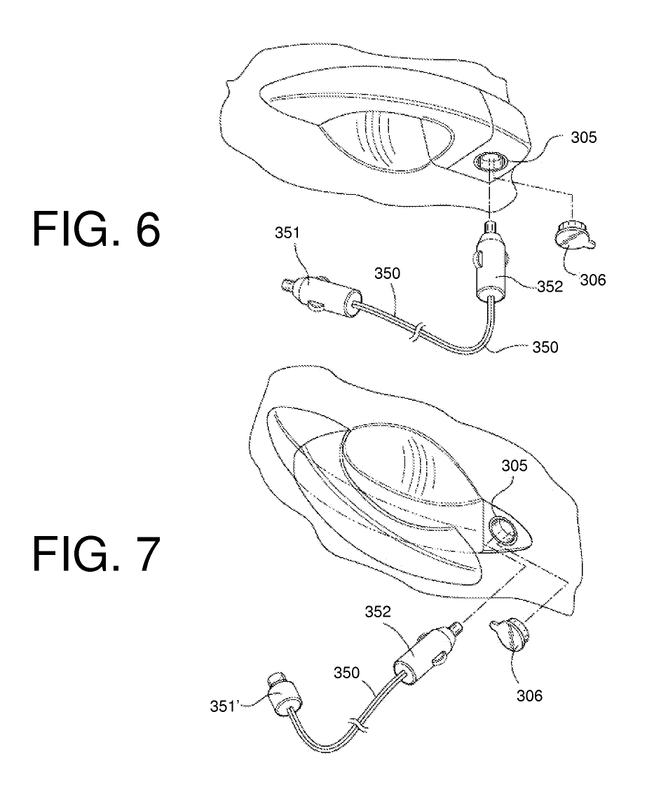

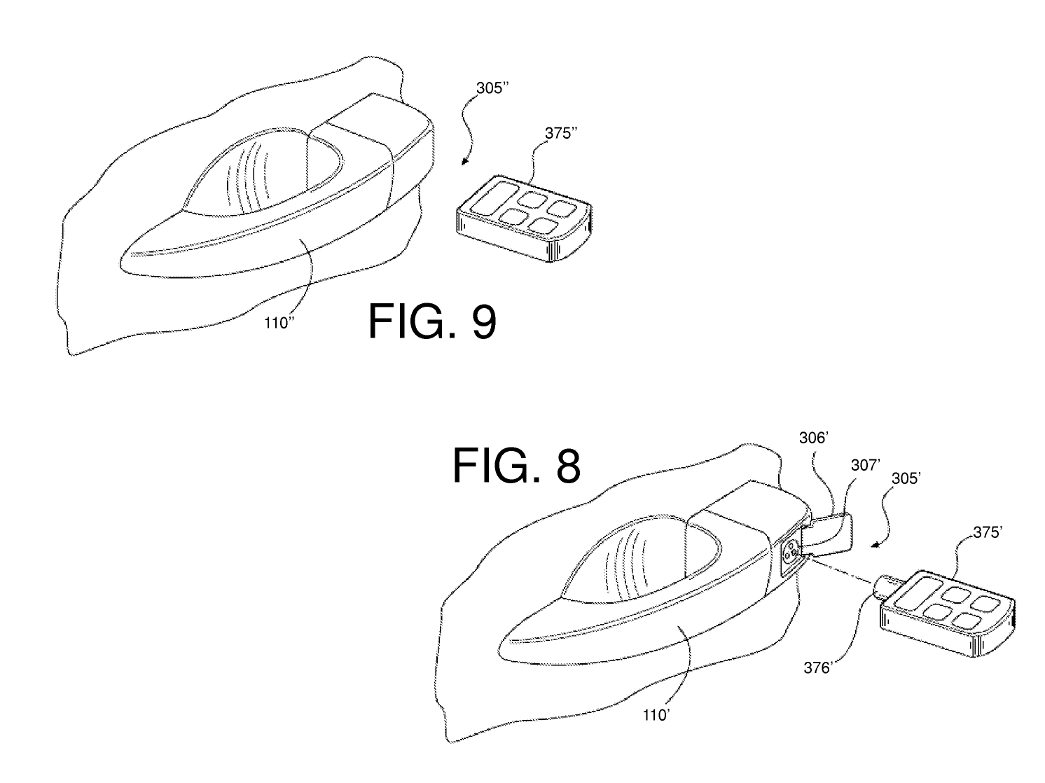

In one embodiment, the external power source may be combined with the vehicle's key fob remote 375, 375′, and may be capable of physical interconnection with the power transferring means (see FIG. 8) or, alternatively, of wireless power transfer (see FIG. 9).

According to the embodiment of FIG. 8, for example, a remote access device (e.g., a key fob remote) 375′ may comprise the external power source in the form of a battery disposed in the key fob and electrically coupled to contacts provided in a male portion 376′ of the key fob. Male portion 376′ is configured for electrical interconnection with contacts of a female receptacle portion 307′ of the power transferring means 305′ disposed, as shown, in the base of a release handle 110′ beneath a protective cover 306′.

According to the embodiment of FIG. 9, as another example, a remote access device (e.g., a key fob remote) 375″ may comprise the external power source in the form of a battery-powered primary coil for inducing through a magnetic field the generation of an electrical current in the secondary coil of the power transferring means 305″ (disposed, for instance, in the door handle 110″). As will be appreciated, power transfer from the external power source to the power supply via the power transferring means 305″ is effected by simply holding the remote access device 375″ in close proximity to the power transferring means 305″ in order to generate the required current to recharge the power supply.

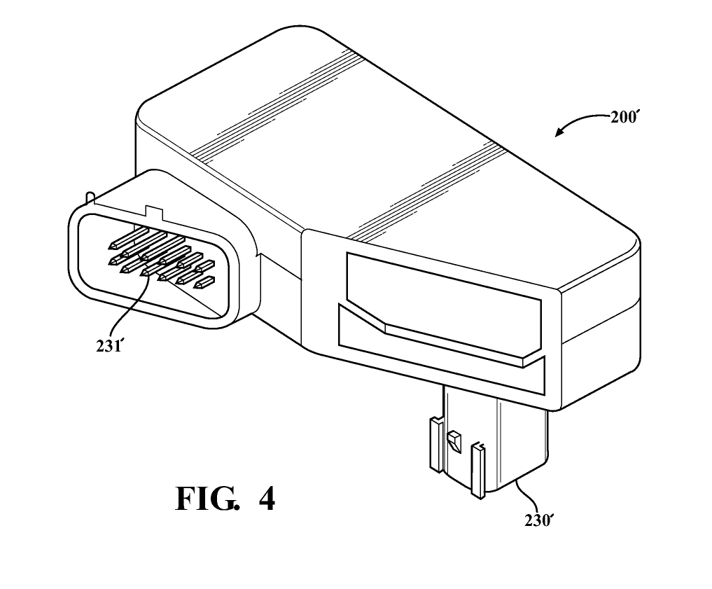

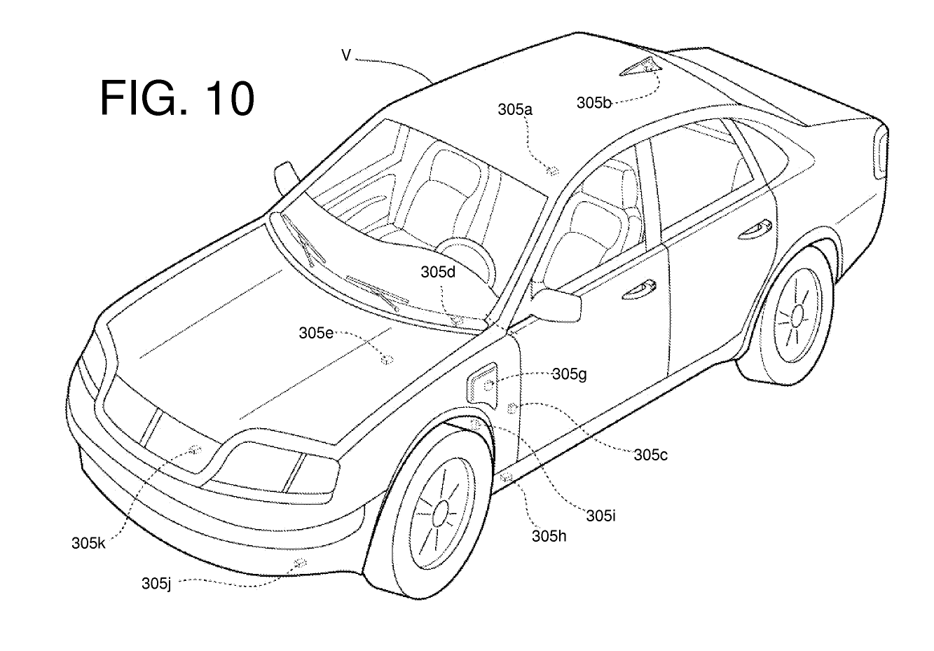

Referring specifically to FIG. 10, there is illustrated a representative vehicle V having shown thereon possible locations for the disposition of externally accessible power transferring means 305. As depicted, such possible locations include one or more of the vehicle roof 305a, the vehicle antenna cover 305b, the vehicle body shell 305c, the leaf screen 305d, the hood 305e, the fender 305f, vents 305g, body trim elements 305h, wheel wells 305i, bumper 305j, and/or the grill 305k. It will be appreciated that the depicted locations are not intended to be exhaustive of possible locations for the power transferring means 305 and, moreover, that any given vehicle may include one or more power transferring means at the depicted, as well as other, locations. Still other exemplary locations for the power transferring means include side view mirror housings or, as shown in FIGS. 6 through 9, on or proximate a vehicle's door handles.

As shown in FIGS. 6, 7 and 8, each receptacle for the power transferring means may be provided with a selectively removable plug or pivotable cover 306, 306′ to keep the receptacle portion of the power transferring means 305 free of debris, ice or other obstruction, as well as to provide a more aesthetically pleasing appearance, when not in use. Similar or other plugs, covers or the like may also be provided for receptacles disposed in other locations about the vehicle, including any of the locations described above in relation to FIG. 10.

Where the external power supply 300 constitutes an external device of conventional manufacture, it will be appreciated that the external power supply may need to be connectable to the power transferring means 305 via an interconnection suitable to the external device. Thus, for example, there is depicted in FIG. 6 an embodiment of the present invention wherein the external power supply comprises a vehicle's 12V power supply, such as a cigarette lighter (not shown), and according to which that power supply is connectable to the power transferring means (indicated generally at 305) via a cable 350 having a plug 351 at one end of conventional construction which is compatible with a 12V power supply port in the charging vehicle. The other end of that cable 350 may, as shown, have a similar plug 352 for receipt in the power transferring means 305.

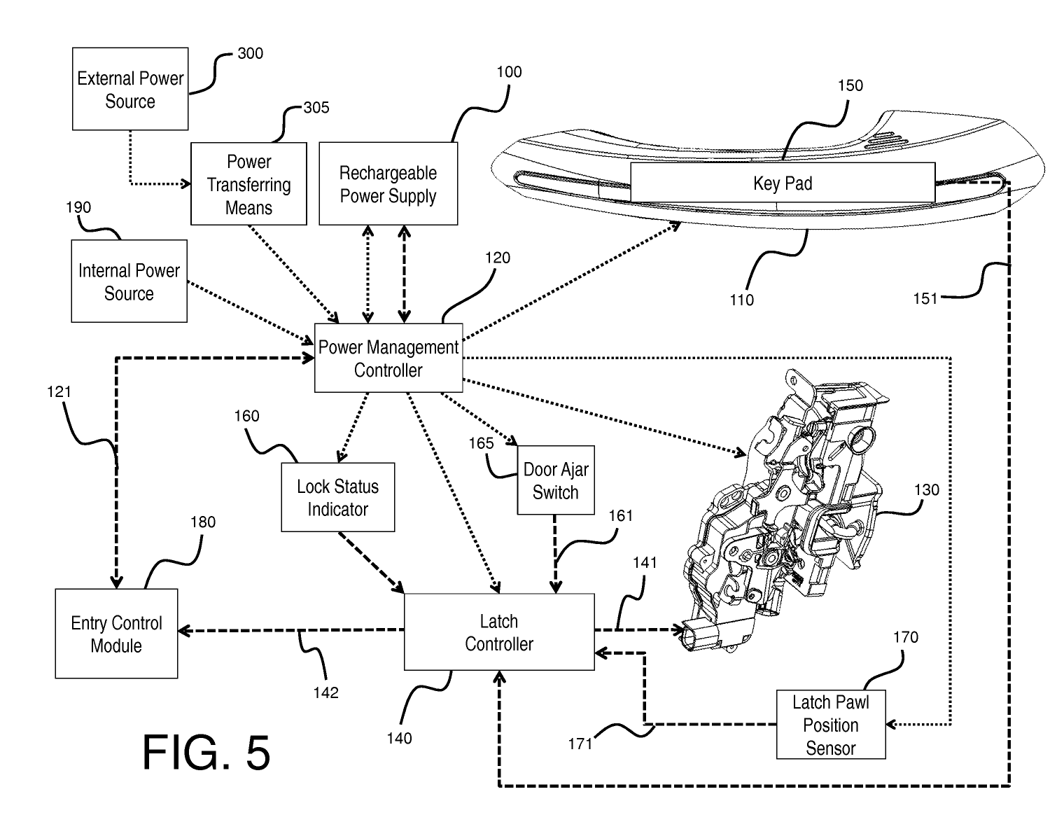

It is to be understood, however, that the cable as described above are not intended to be limiting of the present invention, and that other suitable interconnecting devices may include USB cables, mini-USB cables, etc. Rather, it will be appreciated that the cable or other device for interconnecting the power transferring means to the external power supply 300 may be any known plug/receptacle combination such as, for instance, that shown in the embodiment of FIG. 7, wherein the cable 350 includes at one end a 12V plug 352 of conventional construction for receipt in the power transferring means 305 and, at the opposite end, a plug 351′ of different construction for interconnection with an external power source other than a charging vehicle's cigarette lighter.

Where, according to yet another embodiment of the present invention, the external power supply 300 simply comprises a conventional battery, interconnection with the power transferring means may be effected merely by the provision of suitable contacts at the power transferring means for direct electrical interconnection with the contacts of the battery.

### Entry Authentication Device

Referring again to FIG. 2 as representative, the entry authentication device (e.g., the key pad 150) is disposed on the vehicle for authenticating a user's access to the vehicle, the device being powered (indicated by a dotted line extending between the key pad and the power management controller 120) by the power supply 100 and operatively connected to the latch controller 140 (indicated by the dashed line 151) to provide authentication information to the latch controller 140 that is, as explained herein, locally authenticated by the latch controller 140. Key pad 150 may be of conventional construction in providing a user-accessible interface for entering a predefined access code for establishing a user's authority to access the vehicle.

Conventionally, key pads are placed on or near the handle of at least the driver's door or on the B-pillar proximate the driver's door. The key pad may optionally be formed as part of the same unit comprising the latch controller, power management controller and rechargeable power supply, particularly where the access system is disposed in or proximate the vehicle handle. Alternatively, and as exemplified herein, the key pad may comprise a separate component of the access system, or as a component of the vehicle which is integrated with the access system of the present invention.

On authentication of the authentication information from the key pad 150 or other entry authentication means, the latch controller 140 places the power latch 130 in one of a locked or an unlocked state so that the vehicle door may, respectively, be locked or thereafter opened by user actuation of the release handle.

### Exemplary Operation

In operation of the present invention, the power management controller 120 monitors the charge status of the power supply 100.

When the charge status falls below a predetermined threshold, recharging of the rechargeable power supply 100 via internal power source 190 of the vehicle (such as, for instance, the vehicle ignition system or the vehicle main battery) is effected via the power management controller 120. Preferably, though not necessarily, the power supply 100 is always maintained in a state of sufficient charge to power the access system as herein described.

Preferably, though not necessarily, the power management controller 120, latch controller 140 and any other constituent elements of the inventive system which draw power from the power supply 100 are capable of operating in “standby” or low-power modes during long periods of inactivity. In this fashion, as those skilled in the art will appreciate, the power supply's 100 charge may be conserved for a longer period of time before requiring recharging. However, in the event that the rechargeable power source 100 becomes depleted—at least to the point of being incapable of powering the access system of the present invention—and the vehicle's internal power source 190 is unavailable to recharge the power supply 100 (such as when, for instance, the vehicle's internal power source 190 is “dead”), the access system may optionally include the power transferring means 305 heretofore described to permit the power supply 100 to be recharged via an external power source 300, and/or the key lock cylinder or other purely mechanical means connected to the latch and operative as a purely mechanical fail-safe.

Where the access system of the present invention comprises, as an electromechanical entry means, only a key pad providing access to the vehicle, it will be appreciated that a user's operation of the key pad to place the vehicle in an “unlocked” state, and subsequent actuation of the release handle to effect operation of the latch via the latch controller, will permit entry into the vehicle so long as the rechargeable power supply is sufficiently charged.

Information pertaining to the power supply's charge status is conveyed to the vehicle's body control module by the power management controller.

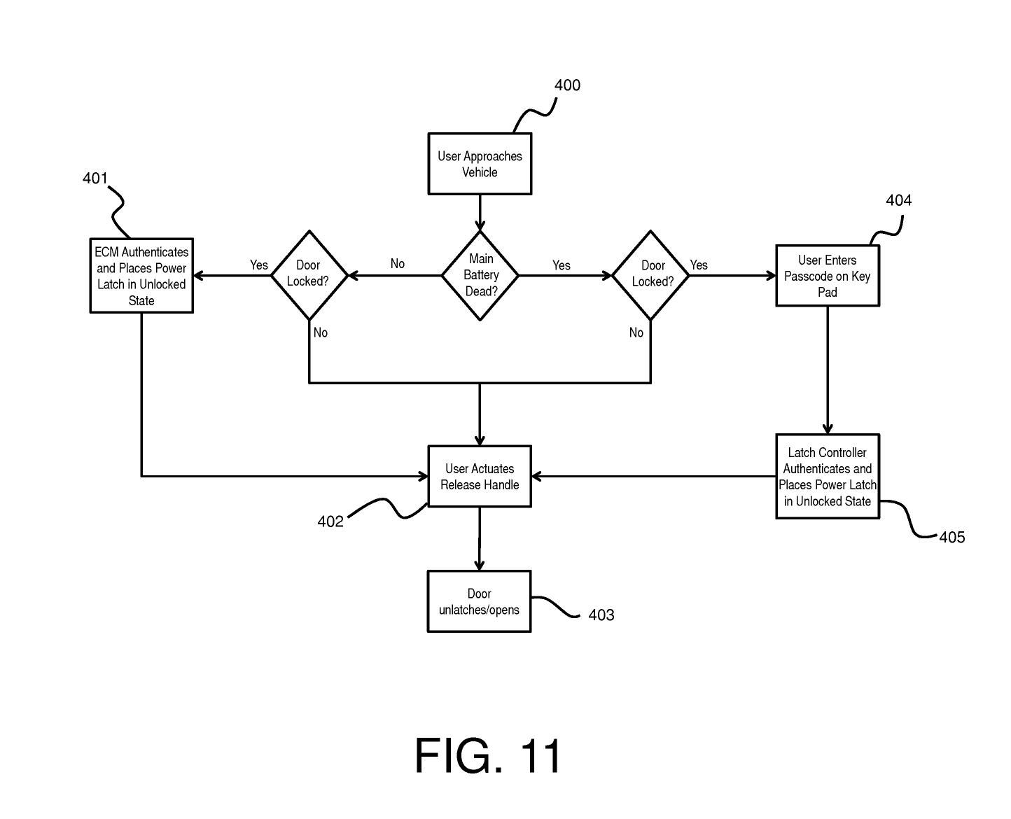

With reference now to the operational flowchart FIG. 11, operation of the access system will be better understood in the context of an exemplary embodiment wherein the vehicle is of the type comprising a conventional remote access system of the passive type, such as described hereinabove, wherein the vehicle's power latches may be placed an unlocked state upon authentication of a signal from the user's key fob remote; provided, of course, that the vehicle's main battery is not so depleted as to be incapable of effecting the operation of the various components of such an access system. Of course, it will be appreciated with the benefit of the present disclosure that the access system of the present invention may be incorporated into vehicles with other types of conventional access systems including, by way of example and not of limitation, active remote entry systems, keypad-mediated remote access systems, etc.

Under normal circumstances (i.e., when the main battery is sufficiently charged), as a user approaches a vehicle for which the user possesses a key fob remote (step 400) the vehicle's access system transmits a challenge signal prompting the key fob remote to transmit the authentication signal in response. The authentication signal is then authenticated by the vehicle's entry controller (labeled “ECM” in FIG. 11) and, upon authentication (step 401), the vehicle's power latches are placed in an unlocked state (presuming their initial state was “locked”) (step 401). The foregoing happens sufficiently rapidly so that, when the user is close enough to actuate the vehicle's door release handle (step 402), the result is that the user can effect operation of the power latch to unlatch and open the vehicle door (step 403).

Where the vehicle is already in an unlocked state, on the other hand, user actuation of the release handle (step 402) effects operation of the power latch to unlatch and open the vehicle door (step 403) without the intermediate authentication step.

Of course, when the vehicle's main battery is dead, the user will be unaware that the foregoing challenge and response steps are not taking place. In consequence, when the user actuates the release handle (step 402), he/she will not be able to effect unlatching and opening of the door. Most fundamentally, this fact may be conveyed to the user by his/her inability to open the vehicle door, although other signals, such as visual or audible cues, may also be provided as part of the present invention.

Where main battery failure is indicated (whether simply through the user's inability to open the door or otherwise), the user then employs the key pad (step 404) to enter an access code that is authenticated by the latch controller as heretofore described. Upon authentication of the access code (step 405), the latch controller places the vehicle's power latch in an unlocked state (step 405) so that, upon the user's subsequent actuation of the release handle (step 402), the door may be unlatched and opened (step 403).

Where, on the other hand, the vehicle is already in an unlocked state and the main battery is depleted, user actuation of the release handle (step 402) effects operation of the power latch to unlatch and open the vehicle door (step 403) without the intermediate authentication step (step 405) since, as heretofore described, the latch controller is operative to receive and store information corresponding to the lock/unlock state of the power latch.

It will be appreciated, as noted elsewhere herein, that the present invention may be employed with any conventional powered access system wherein the access system will not function in the event that the vehicle's main battery is depleted. Such access systems include, by way of non-limiting example, passive and active remote entry systems and keypad entry systems, or any combination thereof.

It will also be appreciated from the preceding disclosure that the present invention is seamlessly integrated with a vehicle's existing electrical systems to provide means to access the vehicle in the event the main battery becomes drained to the point of being incapable of permitting operation of the vehicle's access system(s), while permitting such system(s) to effectively operate as normal from the user's perspective when the main battery is sufficiently charged.

Many modifications and variations of the present disclosure, all of which will be apparent to those skilled in the art having the benefit of this disclosure, are possible in light of the above teachings. Therefore, within the scope of the appended claims, the present disclosure may be practiced other than as specifically described.

The invention in which an exclusive property or privilege is claimed is defined as follows:

1. An access system for a vehicle of the type having at least one onboard electrical power source comprising a main battery, at least one door with a power latch powered by the main battery and a user actuatable release handle for opening the at least one door, the access system facilitating access to the vehicle when the vehicle's main battery is incapable of supplying sufficient power for actuating the power latch, the access system comprising:
(a) a power supply disposed in one of the at least one door or the release handle, the power supply supplying power to the power latch;
(b) at least one entry authentication device provided on the vehicle for receiving one or more inputs for authenticating a user's access to the vehicle, the entry authentication device powered by the power supply;
(c) a latch controller positioned in the vehicle, the latch controller powered by the power supply, the latch controller operatively connected to the power latch and the at least one entry authentication device to receive information from the at least entry authentication device corresponding to the one or more inputs, and the latch controller operative to authenticate a user's access to the vehicle based on the information received from the at least one entry authentication device; and
wherein, on authentication of the information received from the entry authentication device, the latch controller places the power latch in one of a locked or an unlocked state, the unlocked state being characterized in that the power latch is operatively coupled to the release handle, and the locked state being characterized in that the power latch is operatively uncoupled from the release handle.

2. The vehicle access system of claim 1, wherein the entry authentication device is a key pad, the one or more inputs are a sequence of numbers and/or letters corresponding to one or more keys on the key pad, and authentication of the information received from the entry authentication device corresponds to one or more inputs entered according to a predefined passcode.

3. The vehicle access system of claim 2, wherein the key pad is provided on one of the release handle or vehicle door.

4. The vehicle access system of claim 1, wherein at least the latch controller and power supply are provided within a unitary housing mountable in a vehicle door.

5. The vehicle access system of claim 1, wherein the power supply comprises a rechargeable power supply, and the access system further comprises a power management controller for monitoring the status of the rechargeable power supply and for controlling recharging of the rechargeable power supply via the vehicle's at least one onboard electrical power source, the power management controller disposed in one of the at least one door or the release handle and powered by the rechargeable power supply.

6. The vehicle access system of claim 5, wherein at least the latch controller, power management controller and power supply are all provided within a unitary housing mountable in a vehicle door.

7. The vehicle access system of claim 5, further comprising means positioned in the vehicle for transferring power from an external power supply to the rechargeable battery via the power management controller in order to selectively recharge the rechargeable power supply.

8. The vehicle access system of claim 7, wherein the external power supply is directly connectable to the power transferring means.

9. The vehicle access system of claim 7, wherein the external power supply is indirectly connectable to the power transferring means via induction.

10. The vehicle access system of claim 5, wherein the at least one onboard electrical power source includes a 12 Volt DC power source separate from the vehicle's main battery, and wherein further the power management controller controls recharging of the rechargeable power supply via said 12 Volt DC power source separate.

11. The vehicle access system of claim 10, wherein said 12 Volt DC power source comprises the power source for the vehicle's ignition system.

11. The vehicle access system of claim 1, wherein the vehicle is of the type including a power latch having a latch pawl and a latch pawl switch, and wherein the access system further comprises the latch controller being operatively connected to the latch pawl switch, and wherein the latch pawl switch is operative to convey information to the latch controller respecting the position of the latch pawl.

12. The vehicle access system of claim 1, wherein the vehicle is of the type including a door ajar switch, and wherein the access system further comprises the latch controller being operatively connected to the door ajar switch, and wherein the door ajar switch is operative to convey information to the latch controller respecting whether the vehicle door is opened or closed.

13. The vehicle access system of claim 5, wherein the vehicle is of the type further comprising an entry control module powered by the vehicle's main battery, and wherein further the access system comprises:
the entry control module operatively connected to the power latch and the entry authentication device via the latch controller, the entry control module operative to receive information from the entry authentication device corresponding to the one or more inputs, and the entry control module operative to authenticate a user's access to the vehicle based on the information received from the at least one entry authentication device and to place the power latch in one of the locked or unlocked states thereof via the latch controller;
the power management controller operatively connected to the entry control module, and the power management controller operative to determine, via the entry control module, when the vehicle's main battery is capable of supplying sufficient power for actuating the power latch; and
wherein, when the power management controller determines that the vehicle's main battery is capable of supplying sufficient power for actuating the power latch, the access system is not powered by the rechargeable power supply, and the entry control module exclusively authenticates a user's access to the vehicle based on the information received from the at least one entry authentication device, and exclusively places the power latch in one of the locked or unlocked states thereof.

14. An apparatus for a vehicle of the type having at least one onboard electrical power source comprising a main battery, at least one door with power latch powered by the main battery and a user-actuatable release handle for opening the at least one door, and at least one entry authentication device provided on the vehicle for receiving one or more inputs for authenticating a user's access to the vehicle, the apparatus facilitating access to the vehicle when the vehicle's main battery is incapable of supplying sufficient power for actuating the power latch, the apparatus comprising:
(a) a power supply positionable in one of the at least one door or the release handle, the power supply operatively connectable to the power latch and the entry authentication device so as to supply power thereto;
(b) a latch controller positionable in the vehicle, the latch controller powered by the power supply, the latch controller operatively connectable to the power locks and the at least one entry authentication device to receive information from the at least entry authentication device corresponding to the one or more inputs, and the latch controller operative to authenticate a user's access to the vehicle based on the information received from the at least one entry authentication device; and
wherein, on authentication of the information received from the entry authentication device, the latch controller is operative to place the power latch in one of a locked or an unlocked state, the unlocked state being characterized in that the power latch is operatively coupled to the release handle, and the locked state being characterized in that the power latch is operatively uncoupled from the release handle.

15. The apparatus of claim 14, wherein the entry authentication device is a key pad, the one or more inputs are a sequence of numbers and/or letters corresponding to one or more keys on the key pad, and authentication of the information received from the entry authentication device corresponds to one or more inputs entered according to a predefined passcode.

16. The apparatus of claim 15, wherein the key pad is provided on one of the release handle or vehicle door.

17. The apparatus of claim 14, wherein at least the latch controller and power supply are provided within a unitary housing mountable in a vehicle door.

18. The apparatus of claim 14, wherein the power supply comprises a rechargeable power supply, and the apparatus further comprises a power management controller for monitoring the status of the rechargeable power supply and for controlling recharging of the rechargeable power supply via the vehicle's at least one onboard electrical power source, the power management controller disposed in one of the at least one door or the release handle and powered by the rechargeable power supply.

19. The apparatus of claim 18, wherein at least the latch controller, power management controller and power supply are all provided within a unitary housing mountable in a vehicle door.

20. The apparatus of claim 18, further comprising means positioned in the vehicle for transferring power from an external power supply to the rechargeable battery via the power management controller in order to selectively recharge the rechargeable power supply.

21. The apparatus of claim 20, wherein the external power supply is directly connectable to the power transferring means.

22. The apparatus of claim 20, wherein the external power supply is indirectly connectable to the power transferring means via induction.

23. The apparatus of claim 18, wherein the at least one onboard electrical power source includes a 12 Volt DC power source separate from the vehicle's main battery, and wherein further the power management controller controls recharging of the rechargeable power supply via said 12 Volt DC power source separate.

24. The apparatus of claim 23, wherein said 12 Volt DC power source comprises the power source for the vehicle's ignition system.

25. The apparatus of claim 14, wherein the vehicle is of the type including a power latch having a latch pawl and a latch pawl switch, and wherein the apparatus further comprises the latch controller being operatively connectable to the latch pawl switch, and wherein the latch pawl switch is operative to convey information to the latch controller respecting the position of the latch pawl.

26. The apparatus of claim 1, wherein the vehicle is of the type including a door ajar switch, and wherein the apparatus further comprises the latch controller being operatively connectable to the door ajar switch, and wherein the door ajar switch is operative to convey information to the latch controller respecting whether the vehicle door is opened or closed.

27. The apparatus of claim 5, wherein the vehicle is of the type further comprising an entry control module powered by the vehicle's main battery, and wherein further the apparatus comprises:
the entry control module operatively connectable to the power latch and the entry authentication device via the latch controller, the entry control module operative to receive information from the entry authentication device corresponding to the one or more inputs, and the entry control module operative to authenticate a user's access to the vehicle based on the information received from the at least one entry authentication device and to place the power latch in one of the locked or unlocked states thereof via the latch controller;
the power management controller operatively connectable to the entry control module, and the power management controller operative to determine, via the entry control module, when the vehicle's main battery is capable of supplying sufficient power for actuating the power latch; and
wherein, when the power management controller determines that the vehicle's main battery is capable of supplying sufficient power for actuating the power latch, the access system is not powered by the rechargeable power supply, and the entry control module exclusively authenticates a user's access to the vehicle based on the information received from the at least one entry authentication device, and exclusively places the power latch in one of the locked or unlocked states thereof.
